(19) United States
(12) Patent Application Publication
(10) Pub. No.: US 2025/0081190 A1
(43) Pub. Date: Mar. 6, 2025

(54) WIRELESS COMMUNICATION METHOD AND DEVICE THEREOF

(71) Applicant: Lenovo (Beijing) Limited, Beijing (CN)

(72) Inventors: Xuefeng LAI, Beijing (CN); Haoyu ZHAO, Beijing (CN)

(21) Appl. No.: 18/815,593

(22) Filed: Aug. 26, 2024

(30) Foreign Application Priority Data
Aug. 30, 2023 (CN) 202311111620.8

(51) Int. Cl. H04W 72/1268; H04W 48/08; H04W 72/54

(52) U.S. Cl. CPC H04W 72/1268; H04W 48/08; H04W 72/54

(57) ABSTRACT

A wireless communication method includes obtaining an uplink signal, obtaining a first transmission parameter and a second transmission parameter of the uplink signal based on the uplink signal and transmission data carried in the uplink signal, determining a target transmission device based on the second transmission parameter, selecting a first transmission sub-parameter associated with the target transmission device in the first transmission parameter, selecting a second transmission sub-parameter associated with the target transmission device in the second transmission parameter, and determining a third transmission parameter of the uplink signal based on the first transmission sub-parameter and the second transmission sub-parameter.

### CROSS-REFERENCE TO RELATED APPLICATION

This application claims priority to Chinese Patent Application No. 202311111620.8, filed on Aug. 30, 2023, the entire content of which is incorporated herein by reference.

### TECHNICAL FIELD

The present disclosure generally relates to the field of wireless communication technologies and, more particularly, to a wireless communication method and device thereof.

### BACKGROUND

At present, in an indoor coverage scenario, multiple remote radio units (RRUs) of a same frequency are merged into one cell. The merged cell has a same cell ID and a common channel, to eliminate interference between cells of the same frequency.

After the multiple RRUs are merged, the difficulty and amount of calculation of channel estimation will increase because of the participation of the multiple RRUs in the process of channel estimation based on uplink signals. For a processing terminal with limited computing power, communication delays will increase, causing a serious decline in communication quality and efficiency. In particular, when the RRUs support multi-antenna transmission, the computing resources for channel estimation will be occupied exponentially, further reducing the communication quality.

### SUMMARY

In accordance with the present disclosure, there is provided a wireless communication method including obtaining an uplink signal, and obtaining a first transmission parameter and a second transmission parameter of the uplink signal based on the uplink signal and transmission data carried in the uplink signal. The first transmission parameter represents a demodulation attribute of the uplink signal transmission data and the second transmission parameter represents a quality attribute of the uplink signal transmission data. The method further includes determining a target transmission device based on the second transmission parameter, selecting a first transmission sub-parameter associated with the target transmission device in the first transmission parameter, and selecting a second transmission sub-parameter associated with the target transmission device in the second transmission parameter. The first transmission sub-parameter and the second transmission sub-parameter are associated with an uplink signal of the target transmission device. The method also includes determining a third transmission parameter of the uplink signal based on the first transmission sub-parameter and the second transmission sub-parameter.

Also in accordance with the present disclosure, there is provided an electronic device including at least one processor, and at least one memory storing one or more instructions that, when executed by the at least one processor, cause the at least one processor to obtain an uplink signal, and obtain a first transmission parameter and a second transmission parameter of the uplink signal based on the uplink signal and transmission data carried in the uplink signal. The first transmission parameter represents a demodulation attribute of the uplink signal transmission data and the second transmission parameter represents a quality attribute of the uplink signal transmission data. The one or more instructions, when executed by the at least one processor, further cause the at least one processor to determine a target transmission device based on the second transmission parameter, select a first transmission sub-parameter associated with the target transmission device in the first transmission parameter, and select a second transmission sub-parameter associated with the target transmission device in the second transmission parameter. The first transmission sub-parameter and the second transmission sub-parameter are associated with an uplink signal of the target transmission device. The one or more instructions, when executed by the at least one processor, also cause the at least one processor to determine a third transmission parameter of the uplink signal based on the first transmission sub-parameter and the second transmission sub-parameter.

Also in accordance with the present disclosure, there is provided a non-transitory computer-readable storage medium storing one or more instructions that, when executed by at least one processor, cause the at least one processor to obtain an uplink signal, and obtain a first transmission parameter and a second transmission parameter of the uplink signal based on the uplink signal and transmission data carried in the uplink signal. The first transmission parameter represents a demodulation attribute of the uplink signal transmission data and the second transmission parameter represents a quality attribute of the uplink signal transmission data. The one or more instructions, when executed by the at least one processor, further cause the at least one processor to determine a target transmission device based on the second transmission parameter, select a first transmission sub-parameter associated with the target transmission device in the first transmission parameter, and select a second transmission sub-parameter associated with the target transmission device in the second transmission parameter. The first transmission sub-parameter and the second transmission sub-parameter are associated with an uplink signal of the target transmission device. The one or more instructions, when executed by the at least one processor, also cause the at least one processor to determine a third transmission parameter of the uplink signal based on the first transmission sub-parameter and the second transmission sub-parameter.

### BRIEF DESCRIPTION OF THE DRAWINGS

FIG. 1 is a flowchart of a wireless communication method consistent with the present disclosure.

FIG. 2 is another flowchart of a wireless communication method consistent with the present disclosure.

FIG. 3 is a schematic structural diagram of an application network consistent with the present disclosure.

FIG. 4 is a schematic diagram showing channel estimation consistent with the present disclosure.

FIG. 5 is another flowchart of a wireless communication method consistent with the present disclosure.

FIG. 6 is a schematic structural diagram of a wireless communication device consistent with the present disclosure.

FIG. 7 is a schematic structural diagram of an electronic device consistent with the present disclosure.

### DETAILED DESCRIPTION OF THE EMBODIMENTS

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure. Various modifications may be made to the embodiments of the present disclosure. Thus, the described embodiments should not be regarded as limiting, but are merely examples. Those skilled in the art will envision other modifications within the scope and spirit of the present disclosure.

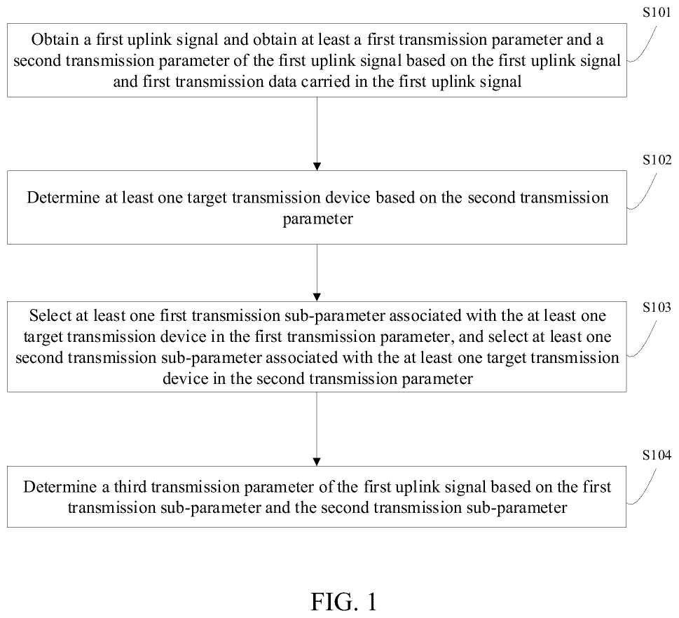

The present disclosure provides a wireless communication method. In one embodiment shown in FIG. 1, the collection method includes S101 to S104.

At S101, a first uplink signal is obtained, and, based on the first uplink signal and first transmission data carried in the first uplink signal, at least a first transmission parameter and a second transmission parameter of the first uplink signal are obtained.

In one embodiment of the present disclosure, the first uplink signal may be an uplink signal carrying a reference signal, and may be various uplink signals sent by the user equipment (UE) to the network side. The reference signal may include at least one of a demodulation reference signal (DMRS), a phase tracking reference signal (PTRS), a channel state information reference signal (CSI-RS), or a sounding reference signal (SRS). The reference signal may be a signal carried in a fixed time slot in a message frame, and may have the certainty of data content compared with the data to be transmitted. Therefore, the network side may perform channel estimation based on the first uplink signal to determine channel parameters of the uplink channel, and use the determined channel parameters to parse the valid data part in the first uplink signal to determine the valid transmission data.

The first transmission parameter may represent the demodulation attribute of the first uplink signal transmission data. As an example, the first transmission parameter may be a channel parameter, such as a channel parameter obtained by channel estimation or the like. The second transmission parameter may represent the quality attribute of the first uplink signal transmission data. As an example, the second transmission parameter may include a noise parameter, a signal-to-noise ratio parameter, etc.

In one embodiment, as an implementation method, the technical solution of the embodiments of the present disclosure may be applied to a scenario where the UE accesses the BBU through multiple RRUs. When there are multiple RRUs to form a larger co-frequency coverage cell, the UE may establish an uplink channel connection with the BBU through at least one of the RRUs and transmit relevant data.

The technical solution of the embodiments of the present disclosure is not limited to the scenario where the UE establishes an uplink channel connection with the BBU through the RRUs. In another embodiment, the technical solution of the embodiments of the present disclosure may also be applied to a scenario where the UE establishes an uplink channel connection with the target base station through a relay station, etc.

At S102, at least one target transmission device is determined based on the second transmission parameter.

In one embodiment of the present disclosure, the target transmission device may be determined based on the second transmission parameter. In the application scenario of the embodiments of the present disclosure, since there are multiple transmission devices for uplink access, when the UE accesses a network through the transmission devices, the UE may select one transmission device with better signal quality for channel access. Therefore, for one transmission device without actual channel access, the noise parameter in its channel may be strong. Therefore, through the second transmission parameter of the first uplink signal, it may be determined which transmission device the uplink signal is actually transmitted through. By determining the transmission device that actually accesses the effective uplink signal, the embodiment of the present disclosure may effectively exclude the uplink signals of other transmission devices when predicting the overall channel, and it may be no longer necessary to perform related calculations for prediction, which may greatly reduce the calculation complexity, improve the calculation efficiency, and save the calculation resources of the communication nodes.

In one embodiment of the present disclosure, the target transmission device may be determined based on the second transmission parameter of the first uplink signal, that is, it may be determined which transmission devices actually participate in the transmission of the first uplink signal, to be clearly excluded in the subsequent channel estimation and reduce the overall calculation amount.

In one embodiment, determining the at least one target transmission device from the effective transmission devices includes: determining all wireless units that transmit the first uplink signal based on the second transmission parameter; determining the transmission devices (also referred to as “candidate transmission devices”) to which the wireless units belong; calculating the sum of third transmission sub-parameters of all wireless units of each transmission device, and sorting the sums by numerical values, where the third transmission sub-parameter may be a sub-parameter in the second transmission parameter; determining transmission devices with the smallest sum as the at least one target transmission device. One wireless unit may be an antenna system. The third transmission sub-parameter may include a noise average variance, etc., or other parameters reflecting channel quality such as a power parameter, etc.

In another embodiment, selecting the at least one target transmission device from the effective transmission devices may include: determining all wireless units that transmit the first uplink signal based on the second transmission parameters; determining the transmission devices to which the wireless units belong; calculating the sums of the third transmission sub-parameters of all wireless units of each transmission device, and sorting the sums by numerical values, where the third transmission sub-parameter is a sub-parameter in the second transmission parameter; determining transmission devices corresponding to the sums less than a first set threshold as the at least one target transmission device. When it is determined that the number of transmission devices corresponding to the sums less than the first set threshold exceeds the second set threshold, a set number of transmission devices may be selected in ascending order as the at least one target transmission device. Mainly considering the amount of calculation, in the process of determining the target transmission devices, it may be likely that a large number of target transmission devices are determined, and the purpose of reducing the amount of calculation cannot be achieved. An appropriate number of target transmission devices may be selected according to the order.

At S103, at least one first transmission sub-parameter associated with the at least one target transmission device is selected from the first transmission parameter, and at least one second transmission sub-parameter associated with the at least one target transmission device is selected from the second transmission parameter.

In one embodiment of the present disclosure, after the at least one target transmission device is determined, the sub-parameter associated with the at least one target transmission device in the first transmission parameters may be determined based on the identification information of the at least one target transmission device, to determine the parameter more relevant to the actual channel and perform channel estimation more accurately.

The first transmission sub-parameter and the second transmission sub-parameter may be associated with the uplink signal associated with the at least one target transmission device.

At S104, a third transmission parameter of the first uplink signal is determined based on the first transmission sub-parameter and the second transmission sub-parameter.

In one embodiment of the present disclosure, the third transmission parameter may include relevant parameters of the estimated transmission channel. By determining the at least one target transmission device for the actual transmission of the uplink signal and accurately determining the relevant parameter for channel estimation, the channel estimation based on the selected relevant parameters may be also more accurate. In one embodiment, the third transmission parameter may include a transmission channel parameter related to some or a certain one of the at least one target transmission device, or it may be a comprehensive channel parameter of the entire transmission device based on correction.

In one embodiment, the transmission device or the UE may be a transmission device supporting multiple antennas, or a transmission device supporting a single antenna. The channel estimation and determination of the target transmission parameters in the embodiments of the present disclosure are not limited by the number of antennas of the transmission device, and only impact the computational complexity.

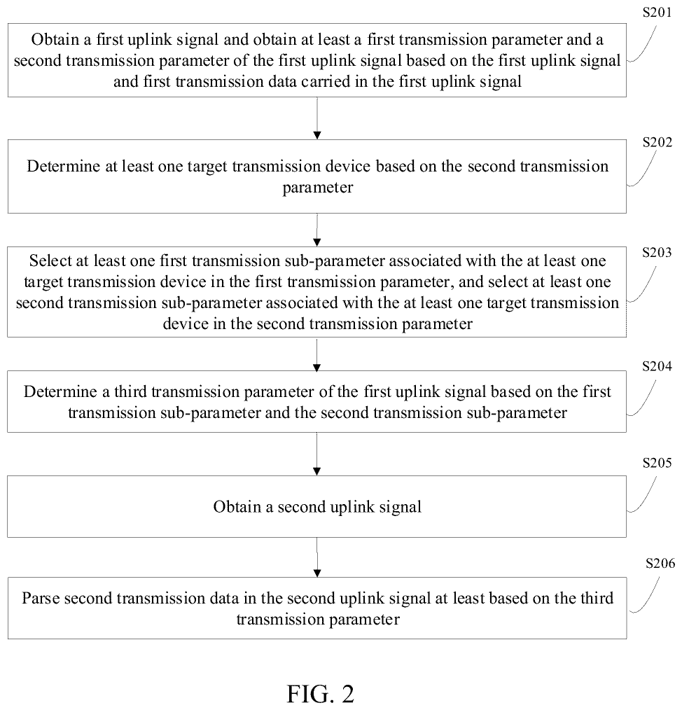

In another embodiment shown in FIG. 2, the wireless communication method includes S201 to S206.

At S201, a first uplink signal is obtained, and at least a first transmission parameter and a second transmission parameter of the first uplink signal are obtained based on the first uplink signal and first transmission data carried in the first uplink signal.

In one embodiment, the implementation of S201 may be similar to S101 in the previous embodiments, and its details are not repeated here.

At S202, at least one target transmission device is determined based on the second transmission parameter.

In one embodiment, the implementation of S202 may be similar to S102 in the previous embodiments, and its details are not repeated here.

At S203, at least one first transmission sub-parameter associated with the at least one target transmission device is selected from the first transmission parameter, and at least one second transmission sub-parameter associated with the at least one target transmission device is selected from the second transmission parameter.

In one embodiment, the implementation of S203 may be similar to S103 in the previous embodiments, and its details are not repeated here.

At S204, a third transmission parameter of the first uplink signal is determined based on the first transmission sub-parameter and the second transmission sub-parameter.

In one embodiment, the implementation of S204 may be similar to S104 in the previous embodiments, and its details are not repeated here.

At S205, a second uplink signal is obtained.

In one embodiment, the second uplink signal may be a signal located in the first uplink signal, and the second uplink signal may be a complete uplink transmission signal carrying the first uplink signal, for example, a complete data transmission frame.

At S206, second transmission data in the second uplink signal is parsed based at least on the third transmission parameters.

In one embodiment, the third transmission parameter may be directly determined according to the first uplink signal, and the first uplink signal may be a signal carried in the second uplink signal and similar to a reference signal. Therefore, when the data in the second uplink signal is parsed based on the third transmission parameter determined according to the first uplink signal, the parsed data may be very accurate. The third transmission parameter may even continue to be used for parsing the valid transmission data in the subsequent uplink signal.

In one embodiment, the first uplink signal may be a sub-signal in the second uplink signal, and the first transmission data may be sub-data in the second transmission data.

In one embodiment, obtaining at least the first transmission parameter and the second transmission parameter of the first uplink signal may include: determining the first uplink signal in the timing sequence in the second uplink signal in response to the first attribute information of the second uplink signal; determining the correlation parameter between the first uplink signal and the first transmission data, and determining the correlation parameter as the first transmission parameter; calculating a fourth transmission parameter based on the first transmission parameter and the first uplink signal, and calculating the second transmission parameter based on the fourth transmission parameter. In the present embodiment, the first attribute information may be information of the message frame format, or attribute information related to the reference signal carrying position and carrying mode. The fourth transmission parameter may be a parameter related to signal noise, and the second transmission parameter may be a parameter related to signal noise calculated based on the fourth transmission parameter. As an example, the fourth transmission parameter may be a noise value, and the second transmission parameter may be an average value of the noise or a noise average variance.

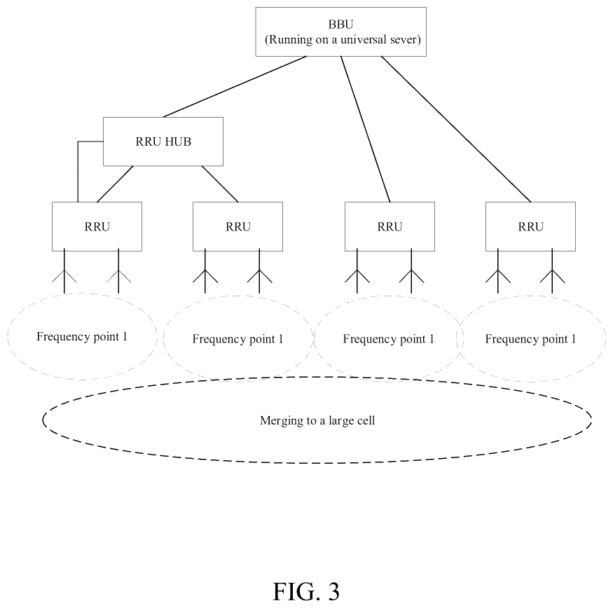

FIG. 3 shows a schematic diagram of the structure of the network applied in the embodiments of the present disclosure. As shown in FIG. 3, the technical solution of the embodiments of the present disclosures, when applied to the scenario of indoor coverage, needs to merge multiple RRUs of the same frequency into one cell, and the merged cell has the same cell ID and common channel, such that the interference between cells of the same frequency may be eliminated, and the difficulty of network planning and optimization is also reduced, and the frequent cell switching of the terminal is avoided, thereby reducing the possibility of dropped calls, enhancing coverage, and avoiding the same-frequency interference between cells. However, this method of merging the RRUs of the same frequency into one cell also brings some problems in data processing. Especially in the process of channel estimation and data demodulation, the UE is able to theoretically access all RRUs. Therefore, when the channel estimation and data demodulation are performed on the premise of all RRU access, channel estimation may not be accurate, and the amount of calculation may be huge. In particular, when the RRUs support multiple antennas, the entire amount of calculation may increase exponentially.

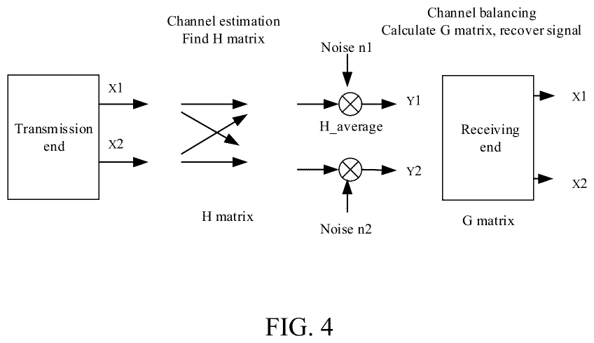

In the multi-antenna communication process, the antenna signal of the transmitting end may be received by all antennas of the receiving end, and the signal may be distorted. To ensure that the receiving end is able to correctly decode the signal, the best way may be to first eliminate the distortion or noise imposed by the channel from the received signal. As shown in FIG. 4, which is a schematic diagram of channel estimation, it is needed to determine the characteristics of the channel through which the signal passes. The process of characterizing the channel is called channel estimation, and the process of using the characteristics of the channel to eliminate the distortion and noise imposed on the signal is called channel equalization. To find out the characteristics of the channel in channel estimation, a set of predefined signals (called reference signals) are embedded in the transmitted sequence. When these reference signals are transmitted through the channel, they may be distorted with other signals such as attenuation, phase shift, noise, etc. The received reference signals may be detected/decoded at the receiving end, and the transmitted reference signals may be compared with the actually received reference signals, and the correlation between them may be found. Therefore, the channel estimation process may be completed, and a channel matrix (H matrix) may be obtained to reflect the influence of the channel on the distortion of the signal. The channel matrix (H matrix) determined based on the reference signals may be the first transmission parameters in the aforementioned technical solution. Through the H matrix of the channel, a G matrix used in the channel equalization process may be obtained. By multiplying the received signals with the G matrix, the receiving end may restore the signal transmitted by the transmitting end to the greatest extent.

The process of channel estimation may be to determine the H matrix. In one embodiment, the reference signal carried in the uplink signal may be mainly used to estimate the channel frequency response (CFR) corresponding to the reference signal such as the DMRS signal by the least square method, that is, the H matrix. The reference signal (DMRS) sent by the transmitter may be known at the receiving end, assumed to be X^{dmrs}. The sequence actually received at the frequency domain position corresponding to the DMRS may be Y^{dmrs}.

The process of receiving the corresponding DMRS signal may include:

Without considering the noise:

$${Y}^{dmrs} = H * {X}^{dmrs} \\ H = {Y}^{dmrs} * {( {X}^{dmrs} )}^{- 1} .$$

Considering the noise:

$${Y}^{dmrs} = {H}^{′} * {X}^{dmrs} + Noise .$$

H′ may be the real H matrix. In the initial estimation calculation, H may be used to replace H′. The estimated noise matrix may be

$$Noise = {Y}^{dmrs} - H * {X}^{dmrs} ;$$

the corresponding noise variance may be δ²=E{(Noise−E(Noise))²}=Noise*Noise^{H}.

The noise variance δ² may be the second transmission parameter in the aforementioned technical solution.

Considering the mathematical expectation of the noise E(Noise)==0, the power of the noise may be equal to the variance of the noise.

The channel equalization process may be to obtain the G matrix through the H matrix. Assuming there is no noise, the G matrix may simply be the inverse of the channel matrix (H⁻¹). When there is noise, a model that is able to reflect the noise may be used for channel estimation. As an example, one embodiment may use the minimum mean square error (MMSE) for channel estimation. Those skilled in the art should understand that other estimation models may also be applied to the embodiment of the present disclosure. The main principle of MMSE is to minimize the mean square error by using the statistical characteristics of the received signal. The main purpose of the present embodiment may be to determine a coefficient matrix G that minimizes E{(GY−X)(GY−X)^{H}}E{(GY−X)(GY−X)^{H}}.

By minimizing the above mean square error, it may be obtained that:

$$G = {{H}^{H} ( {HH}^{H} + {δ}^{2} I )}^{- 1} G = {{H}^{H} ( {HH}^{H} + {δ}^{2} I )}^{- 1} ,$$

where I is the unit matrix and H^{H} is the transposed matrix of H.

In one embodiment, the frequency domain signals sent by multiple uplink RRUs may be treated as a multi-antenna array to obtain H and G matrices, as

$$Noise = {Y}^{dmrs} - H * {X}^{dmrs} .$$

Based on the above noise formula, the noise may be obtained as an M*N matrix:

$${δ}^{2} = E \{ {( Noise - E ( Noise ) )}^{2} \} = Noise * {Noise}^{H} ,$$

Noise^{H} is the transposed matrix of the noise Noise.

Through the above noise formula, the noise variance may be obtained, which is an M*N square matrix, where M is the number of antennas of all RRUs and N is the number of uplink layers of the configured UE. If the noise variance matrix is not reduced in dimension, the complexity of the inverse process of calculating the G matrix may increase exponentially with the increase in the number of antennas, and the system may eventually be unable to be implemented due to its high complexity.

In the present disclosure, the calculation complexity of the G matrix may be simplified by reducing the dimension of the noise variance matrix while ensuring the uplink performance of the UE.

The noise variance δ² may be able to reflect which antenna has the uplink signal of the UE. From the M receiving antennas, the noise variances δ² of all antennas belonging to the same RRU may be selected, and the sum of all elements may be calculated and ordered from low to high. In this way, the arrangement of the sums of the noise variances of all antennas of each RRU may be obtained, and the one or two RRUs with the lowest value may be selected. Similarly, the H matrix may be reduced in dimension according to the previously selected RRU, and the G matrix may be calculated and balanced using the reduced-dimensional H and δ², such that the balance between complexity and performance may be achieved without losing the uplink receiving diversity performance. In the present embodiment, one RRU through which the uplink signal is actually transmitted may be the target transmission device. The channel and noise variance only passing through the RRU through which the uplink signal is actually transmitted may be used as valid parameters, and the channel parameters and noise variance passing through other RRUs may all be used as interference parameters. In the channel estimation process, it may not be necessary to consider the channel parameter and noise variance of the RRU that the uplink signal has not passed through.

If each RRU has two antennas for reception and four RRUs are combined for baseband, there may be eight receiving antennas in total. The noise variance matrix after channel estimation is as follows, which reflects the diagonal position of the noise variance of the UE on the RRU:

$$Number of antennas \qquad [ \begin{matrix}{RRU 0}^{} & \begin{matrix}{δ}_{1 , 3}^{2} & {δ}_{1 , 4}^{2} \\ {δ}_{2 , 3}^{2} & {δ}_{2 , 4}^{2}\end{matrix} & \begin{matrix}{δ}_{1 , 5}^{2} & {δ}_{1 , 6}^{2} \\ {δ}_{2 , 5}^{2} & {δ}_{2 , 6}^{2}\end{matrix} & \begin{matrix}{δ}_{1 , 7}^{2} & {δ}_{1 , 8}^{2} \\ {δ}_{2 , 7}^{2} & {δ}_{2 , 8}^{2}\end{matrix} \\ \begin{matrix}{δ}_{3 , 1}^{2} & {δ}_{3 , 2}^{2} \\ {δ}_{4 , 1}^{2} & {δ}_{4 , 2}\end{matrix} & {RRU 1}^{} & \begin{matrix}{δ}_{3 , 5}^{2} & {δ}_{3 , 6}^{2} \\ {δ}_{4 , 5}^{2} & {δ}_{4 , 6}^{2}\end{matrix} & \begin{matrix}{δ}_{3 , 7}^{2} & {δ}_{3 , 8}^{2} \\ {δ}_{4 , 7}^{2} & {δ}_{4 , 8}^{2}\end{matrix} \\ \begin{matrix}{δ}_{5 , 1}^{2} & {δ}_{5 , 2}^{2} \\ {δ}_{6 , 1}^{2} & {δ}_{6 , 2}^{2}\end{matrix} & \begin{matrix}{δ}_{5 , 3}^{2} & {δ}_{5 , 4}^{2} \\ {δ}_{6 , 3}^{2} & {δ}_{6 , 4}^{2}\end{matrix} & {RRU 2}^{} & \begin{matrix}{δ}_{5 , 7}^{2} & {δ}_{5 , 8}^{2} \\ {δ}_{6 , 7}^{2} & {δ}_{6 , 8}^{2}\end{matrix} \\ \begin{matrix}{δ}_{7 , 1}^{2} & {δ}_{7 , 2}^{2} \\ {δ}_{8 , 1}^{2} & {δ}_{8 , 2}^{2}\end{matrix} & \begin{matrix}{δ}_{7 , 3}^{2} & {δ}_{7 , 4}^{2} \\ {δ}_{8 , 3}^{2} & {δ}_{8 , 4}^{2}\end{matrix} & \begin{matrix}{δ}_{7 , 5}^{2} & {δ}_{7 , 6}^{2} \\ {δ}_{8 , 5}^{2} & {δ}_{8 , 6}^{2}\end{matrix} & {RRU 3}^{}\end{matrix} ]$$

It may only be needed to sum all the variances of the matrix mapped to the RRU, and the square matrix with the smallest sum of variances may be the most important RRU corresponding to the UE. All the summed noise variances may be the third transmission sub-parameter. In one embodiment, an empirical value may be set to determine what the sum of variances is such that the UE may have a signal passing through the RRU. When it is larger than the preset empirical threshold value, the probability of the UE appearing on the RRU may be quite small, and it may be considered that the transmission does not go through the RRU. The empirical threshold value here may be the first set threshold.

When the sum of the elements of the above RRU noise variance matrix is RRU0<RRU1<preset threshold<RRU2<RRU3, it may mean that the UE is in the cross coverage of RRU0 and RRU1, and RRU0 is the primary RRU and RRU1 is the secondary RRU. Select the elements in the following formula as the new noise variance matrix:

$$\begin{matrix}Number of antennas \\ \\ \\ \end{matrix} \qquad [ \begin{matrix}{RRU 0}^{} & {\begin{matrix}{δ}_{1 , 3}^{2} & {δ}_{1 , 4}^{2} \\ {δ}_{2 , 3}^{2} & {δ}_{2 , 4}^{2}\end{matrix}}^{\begin{matrix}New noise \\ matrix after \\ dimension \\ reduction\end{matrix}} & \begin{matrix}{δ}_{1 , 5}^{2} & {δ}_{1 , 6}^{2} \\ {δ}_{2 , 5}^{2} & {δ}_{2 , 6}^{2}\end{matrix} & \begin{matrix}{δ}_{1 , 7}^{2} & {δ}_{1 , 8}^{2} \\ {δ}_{2 , 7}^{2} & {δ}_{2 , 8}^{2}\end{matrix} \\ \begin{matrix}{δ}_{3 , 1}^{2} & {δ}_{3 , 2}^{2} \\ {δ}_{4 , 1}^{2} & {δ}_{4 , 2}^{2}\end{matrix} & {RRU 1}^{} & \begin{matrix}{δ}_{3 , 5}^{2} & {δ}_{3 , 6}^{2} \\ {δ}_{4 , 5}^{2} & {δ}_{4 , 6}^{2}\end{matrix} & \begin{matrix}{δ}_{3 , 7}^{2} & {δ}_{3 , 8}^{2} \\ {δ}_{4 , 7}^{2} & {δ}_{4 , 8}^{2}\end{matrix} \\ \begin{matrix}{δ}_{5 , 1}^{2} & {δ}_{5 , 2}^{2} \\ {δ}_{6 , 1}^{2} & {δ}_{6 , 2}^{2}\end{matrix} & \begin{matrix}{δ}_{5 , 3}^{2} & {δ}_{5 , 4}^{2} \\ {δ}_{6 , 3}^{2} & {δ}_{6 , 4}^{2}\end{matrix} & {RRU 2}^{} & \begin{matrix}{δ}_{5 , 7}^{2} & {δ}_{5 , 8}^{2} \\ {δ}_{6 , 7}^{2} & {δ}_{6 , 8}^{2}\end{matrix} \\ \begin{matrix}{δ}_{7 , 1}^{2} & {δ}_{7 , 2}^{2} \\ {δ}_{8 , 1}^{2} & {δ}_{8 , 2}^{2}\end{matrix} & \begin{matrix}{δ}_{7 , 3}^{2} & {δ}_{7 , 4}^{2} \\ {δ}_{8 , 3}^{2} & {δ}_{8 , 4}^{2}\end{matrix} & \begin{matrix}{δ}_{7 , 5}^{2} & {δ}_{7 , 6}^{2} \\ {δ}_{8 , 5}^{2} & {δ}_{8 , 6}^{2}\end{matrix} & {RRU 3}^{}\end{matrix} ]$$

The H matrix calculated by the corresponding parameter G matrix may also select the corresponding position for dimensionality reduction (the framed area in the formula is the effective part, and the others can be ignored):

$$H == \begin{matrix}[ \begin{matrix} \\ \begin{matrix}{h}_{5 , 1} & {h}_{5 , 2} \\ {h}_{6 , 1} & {h}_{6 , 2} \\ {h}_{7 , 1} & {h}_{7 , 2} \\ {h}_{8 , , 1} & {h}_{8 , 2}\end{matrix}\end{matrix} ] & \begin{matrix}\begin{matrix}H matrix after \\ dimension \\ reduction\end{matrix} \\ \\ \\ \end{matrix}\end{matrix}$$

By controlling the H matrix and the noise variance matrix corresponding to the RRUs after dimensionality reduction, the balance between complexity and performance may be flexibly achieved. In the present disclosure, the channel parameter of the RRUs after dimensionality reduction may be selected in the first transmission parameter as the first transmission sub-parameter. The noise variance of the RRUs after dimensionality reduction may be selected in the second transmission parameter as the second transmission sub-parameter. Using the H matrix and the noise variance matrix after dimensionality reduction, the final G matrix may be generated to equalize the frequency domain signal of the RRUs, and finally the restored frequency domain signal may be sent to the next step of baseband processing for demodulation. The final G matrix generated may be the third transmission parameter in the previous embodiments.

The previous embodiments about the selection of the RPUs in channel estimation are used as examples only to illustrate the present disclosure, and do not limit the scope of the present disclosure. For example, the present disclosure may also be applicable to a network communication system with multiple access nodes.

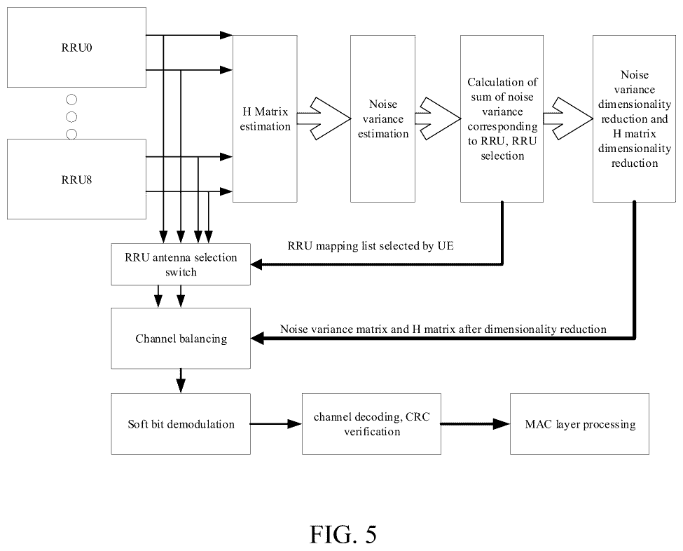

FIG. 5 shows a schematic diagram of the implementation process of the wireless communication method of the present disclosure. As shown in FIG. 5, in the scenario of multiple RRUs, first, the channel estimation of the H matrix may be performed based on the reference signal in the uplink signal, and the noise variance of all RRUs may be summed based on the noise variance estimation. The effective RRU accessed by the UE may be determined based on the sum result. When more than two effective RRUs are determined, only two RRUs with smaller noise variances may be selected as effective RRUs in the order of the noise variances from small to large. Noise variance dimensionality reduction and H matrix dimensionality reduction may be performed based on the selected effective RRUs. According to the dimensionality reduction results, invalid RRUs may be selected to be closed, and channel equalization may be performed based on the reduced H matrix and noise variance, to estimate the channel. Soft bit signal demodulation may be performed based on the estimated channel, channel decoding and CRC check bit verification may be implemented, and effective transmission data may be obtained. The demodulated data may be uploaded to the MAC layer for output.

In the present disclosure, the selection of the RRU frequency domain data for a certain UE may be achieved based on the result of noise estimation of channel estimation, and the dimension of noise variance matrix and channel state matrix may be reduced in dimension through the result of the RRU selection, thereby reducing the complexity of channel equalization and improving the efficiency of channel decoding. The noise variance matrix may be used to determine from which RRU or multiple RRUs the UE reports, realize uplink cross-RRU diversity reception.

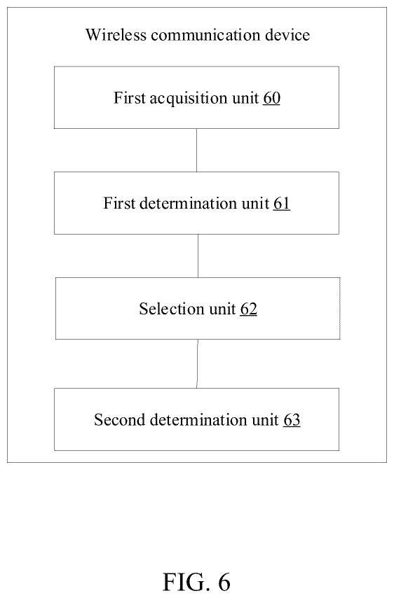

The present disclosure also provides a wireless communication device. In one embodiment shown in FIG. 6 which is a schematic structural diagram of a wireless communication device consistent with the present disclosure, the wireless communication device includes a first acquisition unit 60, a first determination unit 61, a selection unit 62, and a second determination unit 63.

A first acquisition unit 60 may be configured to: obtain a first uplink signal; and based on the first uplink signal and the first transmission data carried in the first uplink signal, obtain at least a first transmission parameter and a second transmission parameter of the first uplink signal. The first transmission parameter may represent a demodulation attribute of the first uplink signal transmission data, and the second transmission parameter may represent a quality attribute of the first uplink signal transmission data.

The first determination unit 61 may be configured to determine at least one target transmission device based on the second transmission parameter.

The selection unit 62 may be configured to select at least one first transmission sub-parameter associated with the target transmission device in the first transmission parameter, and select at least one second transmission sub-parameter associated with the target transmission device in the second transmission parameter. The first transmission sub-parameter and the second transmission sub-parameter may be associated with an uplink signal of the at least one target transmission device associated with one target transmission device.

The second determination unit 63 may be configured to determine a third transmission parameter of the first uplink signal based on the first transmission sub-parameter and the second transmission sub-parameter.

In one embodiment, the wireless communication device may further include a second acquisition unit (not shown in FIG. 6) and a parsing unit (not shown in FIG. 6).

The second acquisition unit may be configured to obtain a second uplink signal.

The parsing unit may be configured to parse second transmission data in the second uplink signal based on at least the first transmission parameter and the third transmission parameter. The first uplink signal may be a sub-signal in the second uplink signal, and the first transmission data may be sub-data in the second transmission data.

In one embodiment, the first acquisition unit 60 may be further configured to: determine the first uplink signal in the timing sequence in the second uplink signal in response to the first attribute information of the second uplink signal; determine the correlation parameter between the first uplink signal and the first transmission data; determining the correlation parameter as the first transmission parameter; calculating the fourth transmission parameter based on the first transmission parameter and the first uplink signal; and calculating the second transmission parameter based on the fourth transmission parameter.

In some embodiments, the selection unit 62 may be further configured to: determine all wireless units that transmit the first uplink signal based on the second transmission parameters, and determine the transmission device to which the wireless units belong; calculate the sum of the third transmission sub-parameters of all wireless units of each transmission device, and sorting the sums by numerical values, where the third transmission sub-parameter may be a sub-parameter in the second transmission parameter; and determine the transmission devices with the smallest sums as the at least one target transmission device.

In one embodiment, the selection unit 62 may be further configured to:
determine all wireless units that transmit the first uplink signal based on the second transmission parameters, and determine the transmission device to which the wireless units belong; calculate the sum of the third transmission sub-parameters of all wireless units of each transmission device, and sort the sums by numerical values, where the third transmission sub-parameter may be a sub-parameter in the second transmission parameter; and determine the transmission devices corresponding to the sum less than the first set threshold as the at least one target transmission device. When it is determined that the number of transmission devices corresponding to the sum less than the first set threshold exceeds the second set threshold, the set number of transmission devices may be selected as the at least one target transmission device in the ascending order.

In various embodiments of the present disclosure, each processing unit may be implemented by one or more central processing units (CPU), graphics processing units (GPU), application specific integrated circuits (ASIC), DSPs, programmable logic devices (PLD), complex programmable logic devices (CPLD), field programmable gate arrays (FPGA), general-purpose processors, controllers, microcontrollers (MCU), microprocessors, or other electronic components.

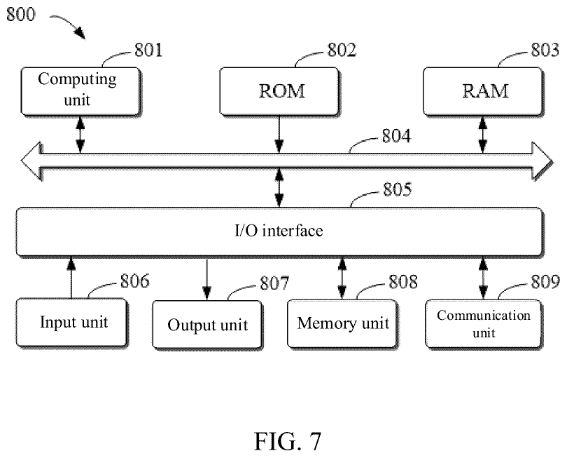

The present disclosure also provides an electronic device that is able to implement the method provided by various embodiments of the present disclosure. As shown in FIG. 7, in one embodiment, the electronic device 800 includes a computing unit 801, which is able to perform various appropriate actions and processes according to a computer program stored in a read-only memory (ROM) 802 or a computer program loaded from a storage unit 808 into a random access memory (RAM) 803. In the RAM 803, various programs or data required for the operation of the electronic device 800 may also be stored. The computing unit 801, the ROM 802, and the RAM 803 may be connected to each other through a bus 804. An input/output (I/O) interface 805 may be also connected to the bus 804.

Multiple components in the electronic device 800 that are connected to the I/O interface 805, may include: an input unit 806, such as a keyboard, a mouse, etc.; an output unit 807, such as various types of displays, speakers, etc.; a storage unit 808, such as a disk, an optical disk, etc.; or a communication unit 809, such as a network card, a modem, a wireless communication transceiver, etc. The communication unit 809 may allow the electronic device 800 to exchange information/data with other devices through a computer network such as the Internet and/or various telecommunication networks.

The computing unit 801 may include a variety of general and/or special processing components with processing and computing capabilities. Some examples of the computing unit 801 include, but are not limited to, a central processing unit (CPU), a graphics processing unit (GPU), various dedicated artificial intelligence (AI) computing chips, various computing units running machine learning model algorithms, digital signal processors (DSPs), or any appropriate processors, controllers, microcontrollers, etc. The computing unit 801 may implement the various methods and processes described above, such as wireless communication methods. For example, in some embodiments, the wireless communication method provided by various embodiments of the present disclosure may be implemented as a computer software program, which is tangibly contained in a machine-readable medium, such as a storage unit 808. In some embodiments, part or all of the computer program may be loaded and/or installed on the electronic device 800 via the ROM 802 and/or the communication unit 809. When the computer program is loaded into the RAM 803 and executed by the computing unit 801, one or more steps of the wireless communication method described above may be performed. Alternatively, in other embodiments, the computing unit 801 may be configured to perform the wireless communication method in any other appropriate manner (e.g., by means of firmware).

Various implementations of the systems and techniques described above herein may be implemented in digital electronic circuit systems, integrated circuit systems, field programmable gate arrays (FPGAs), application specific integrated circuits (ASICs), application specific standard products (ASSPs), systems on chips (SOCs), complex programmable logic devices (CPLDs), computer hardware, firmware, software, and/or combinations thereof. These various implementations may include: being implemented in one or more computer programs that can be executed and/or interpreted on a programmable system including at least one programmable processor, which can be a special purpose or general purpose programmable processor that can receive data and instructions from a storage system, at least one input device, and at least one output device, and transmit data and instructions to the storage system, the at least one input device, and the at least one output device.

The program code for implementing the method of the present disclosure can be written in any combination of one or more programming languages. These program codes can be provided to a processor or a controller of a general-purpose computer, a special-purpose computer or other programmable data processing device, such that the program code, when executed by the processor or controller, enables the function/operation specified in the flow chart and/or the block diagram to be implemented. The program code may be executed completely on the machine, partially on the machine, partially on the machine as an independent software package and partially on a remote machine or completely on a remote machine or server.

In the present disclosure, a machine-readable medium may be a tangible medium, which can contain or store a program used for or in combination with an instruction execution system, a device or an equipment. A machine-readable medium may be a machine-readable signal medium or a machine-readable storage medium. A machine-readable medium may include, but is not limited to, electronic, magnetic, optical, electromagnetic, infrared, or semiconductor systems, devices or equipment, or any suitable combination of the foregoing. More specific examples of machine-readable storage media would include electrical connections based on one or more wires, a portable computer disk, a hard disk, a random access memory (RAM), a read-only memory (ROM), an erasable programmable read-only memory (EPROM or flash memory), optical fibers, a portable compact disk-read-only memory (CD-ROM), an optical storage device, a magnetic storage device, or any suitable combination of the foregoing.

To provide interaction with a user, the systems and techniques described herein may be implemented on a computer having: a display device (such as a cathode ray tube display monitor or a liquid crystal display monitor) for displaying information to the user; or a keyboard and pointing device (e.g., a mouse or trackball) through which the user can provide input to the computer. Other types of devices may also be used to provide interaction with the user; for example, the feedback provided to the user may be any form of sensory feedback (e.g., visual feedback, auditory feedback, or tactile feedback); and input from the user may be received in any form (including acoustic input, voice input, or tactile input).

The systems and techniques described herein may be implemented in a computing system including a backend component (e.g., as a data server), or a computing system including a middleware component (e.g., an application server), or a computing system including a frontend component (e.g., a user computer with a graphical user interface or a web browser through which the user can interact with an implementation of the systems and techniques described herein), or a computing system including any combination of such backend components, middleware components, or frontend components.

The components of the system may be interconnected by digital data communication of any form or medium (e.g., a communication network). Examples of communication networks include: a local area network (LAN), a wide area network (WAN), and the Internet.

A computer system may include a client and a server. The client and server may be generally remote from each other and typically interact through a communication network. The relationship of client and server arises through computer programs running on respective computers and having a client-server relationship to each other. The server may be a cloud server, a server in a distributed system, or a server combined with a blockchain.

Units and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

In the present disclosure, the drawings and descriptions of the embodiments are illustrative and not restrictive. The same drawing reference numerals identify the same structures throughout the description of the embodiments. In addition, figures may exaggerate the thickness of some layers, films, screens, areas, etc., for purposes of understanding and ease of description. It will also be understood that when an element such as a layer, film, region or substrate is referred to as being “on” another element, it may be directly on the other element or intervening elements may be present. In addition, “on” refers to positioning an element on or below another element, but does not essentially mean positioning on the upper side of another element according to the direction of gravity.

The orientation or positional relationship indicated by the terms “upper,” “lower,” “top,” “bottom,” “inner,” “outer,” etc. are based on the orientation or positional relationship shown in the drawings, and are only for the convenience of describing the present disclosure, rather than indicating or implying that the device or element referred to must have a specific orientation, be constructed and operated in a specific orientation, and therefore cannot be construed as a limitation of the present disclosure. When a component is said to be “connected” to another component, it may be directly connected to the other component or there may be an intermediate component present at the same time.

In this disclosure, relational terms such as “first” and “second” are only used to distinguish one entity or operation from another entity or operation, and do not necessarily require or imply that there is such actual relationship or sequence between these entities or operations them. Furthermore, the terms “comprises,” “includes,” or any other variation thereof are intended to cover a non-exclusive inclusion, such that an article or device including a list of elements includes not only those elements, but also other elements not expressly listed. Or it also includes elements inherent to the article or equipment. Without further limitation, an element associated with the statement “comprises a . . . ” does not exclude the presence of other identical elements in an article or device that includes the above-mentioned element.

The disclosed equipment and methods may be implemented in other ways. The device embodiments described above are only illustrative. For example, the division of the units is only a logical function division. In actual implementation, there may be other division methods, such as: a plurality of units or components may be combined, or may be integrated into another system, or some features may be ignored, or not implemented. In addition, the coupling, direct coupling, or communication connection between the components shown or discussed may be through some interfaces, and the indirect coupling or communication connection of the devices or units may be electrical, mechanical, or other forms.

The units described above as separate components may or may not be physically separated. The components shown as units may or may not be physical units. They may be located in one place or distributed to a plurality of network units. Some or all of the units may be selected according to actual needs to achieve the purpose of the solution of the present disclosure.

In addition, all functional units in the embodiments of the present disclosure may be integrated into one processing unit, or each unit may be separately used as a unit, or two or more units may be integrated into one unit. The above-mentioned integration units may be implemented in the form of hardware or in the form of hardware plus software functional units.

All or part of the steps to implement the above method embodiments may be completed by hardware related to program instructions. The aforementioned program may be stored in a computer-readable storage medium. When the program is executed, the steps including the above method embodiments may be executed. The aforementioned storage media may include: removable storage devices, ROMs, magnetic disks, optical disks or other media that may store program codes.

When the integrated units mentioned above in the present disclosure are implemented in the form of software function modules and sold or used as independent products, they may also be stored in a computer-readable storage medium. Based on this understanding, the technical solutions of the embodiments of the present disclosure in essence or those that contribute to the existing technology may be embodied in the form of software products. The computer software products may be stored in a storage medium and include a number of instructions for instructing the product to perform all or part of the methods described in various embodiments of the present disclosure. The aforementioned storage media may include: random access memory (RAM), read-only memory (ROM), electrical-programmable ROM, electrically erasable programmable ROM, register, hard disk, mobile storage device, CD-ROM, magnetic disks, optical disks, or other media that may store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A wireless communication method comprising:
obtaining an uplink signal;
obtaining a first transmission parameter and a second transmission parameter of the uplink signal based on the uplink signal and transmission data carried in the uplink signal, the first transmission parameter representing a demodulation attribute of the uplink signal transmission data and the second transmission parameter representing a quality attribute of the uplink signal transmission data;
determining a target transmission device based on the second transmission parameter;
selecting a first transmission sub-parameter associated with the target transmission device in the first transmission parameter, and selecting a second transmission sub-parameter associated with the target transmission device in the second transmission parameter, the first transmission sub-parameter and the second transmission sub-parameter being associated with an uplink signal of the target transmission device; and
determining a third transmission parameter of the uplink signal based on the first transmission sub-parameter and the second transmission sub-parameter.

2. The method according to claim 1,
wherein the uplink signal is a first uplink signal and the transmission data is first transmission data;
the method further comprising:
obtaining a second uplink signal; and
parsing second transmission data in the second uplink signal at least based on the third transmission parameter;
wherein the first uplink signal is a sub-signal in the second uplink signal, and the first transmission data is sub-data in the second transmission data.

3. The method according to claim 2, wherein obtaining the first transmission parameter and the second transmission parameter of the first uplink signal includes:
in response to attribute information of the second uplink signal, determining the first uplink signal in a timing sequence of the second uplink signal;
determining a correlation parameter between the first uplink signal and the first transmission data as the first transmission parameter;
calculating a fourth transmission parameter based on the first transmission parameter and the first uplink signal; and
calculating the second transmission parameter based on the fourth transmission parameter.

4. The method according to claim 1, wherein determining the target transmission device includes:
determining all wireless units transmitting the uplink signal based on the second transmission parameter, and determining one or more candidate transmission devices to which the wireless units belong;
calculating a sum of third transmission sub-parameters of all wireless units of each candidate transmission device, the third transmission sub-parameter being a sub-parameter in the second transmission parameter; and
determining one of the one or more candidate transmission devices with a smallest sum as the target transmission device.

5. The method according to claim 1, wherein determining the target transmission device includes:
determining all wireless units transmitting the uplink signal based on the second transmission parameter, and determining one or more candidate transmission devices to which the wireless units belong;
calculating a sum of third transmission sub-parameters of all wireless units of each candidate transmission device, the third transmission sub-parameter being a sub-parameter in the second transmission parameter; and
determining one of the one or more candidate transmission devices with the sum less than a threshold as the target transmission device.

6. The method according to claim 1, wherein selecting the target transmission device includes selecting at least one target transmission device based on the second transmission parameter, including:
determining all wireless units transmitting the uplink signal based on the second transmission parameter, and determining one or more candidate transmission devices to which the wireless units belong;
calculating a sum of third transmission sub-parameters of all wireless units of each candidate transmission device, the third transmission sub-parameter being a sub-parameter in the second transmission parameter; and
in response to determining that a number of candidate transmission devices having the sum less than a first threshold exceeds a second set threshold, selecting a set number of candidate transmission devices according to an ascending order of the sums of the candidate transmission devices as the at least one target transmission device.

7. An electronic device comprising:
at least one processor; and
at least one memory storing one or more instructions that, when executed by the at least one processor, cause the at least one processor to:
obtain an uplink signal;
obtain a first transmission parameter and a second transmission parameter of the uplink signal based on the uplink signal and transmission data carried in the uplink signal, the first transmission parameter representing a demodulation attribute of the uplink signal transmission data and the second transmission parameter representing a quality attribute of the uplink signal transmission data;
determine a target transmission device based on the second transmission parameter;
select a first transmission sub-parameter associated with the target transmission device in the first transmission parameter, and select a second transmission sub-parameter associated with the target transmission device in the second transmission parameter, the first transmission sub-parameter and the second transmission sub-parameter being associated with an uplink signal of the target transmission device; and
determine a third transmission parameter of the uplink signal based on the first transmission sub-parameter and the second transmission sub-parameter.

8. The electronic device according to claim 7, wherein
the uplink signal is a first uplink signal and the transmission data is first transmission data;
the one or more instructions, when executed by the at least one processor, further cause the at least one processor to:
obtain a second uplink signal; and
parse second transmission data in the second uplink signal at least based on the third transmission parameter; and
the first uplink signal is a sub-signal in the second uplink signal, and the first transmission data is sub-data in the second transmission data.

9. The electronic device according to claim 8, wherein the one or more instructions, when executed by the at least one processor, further cause the at least one processor to, when obtaining the first transmission parameter and the second transmission parameter of the first uplink signal:
in response to attribute information of the second uplink signal, determine the first uplink signal in a timing sequence of the second uplink signal;
determine a correlation parameter between the first uplink signal and the first transmission data as the first transmission parameter;
calculate a fourth transmission parameter based on the first transmission parameter and the first uplink signal; and
calculate the second transmission parameter based on the fourth transmission parameter.

10. The electronic device according to claim 7, wherein the one or more instructions, when executed by the at least one processor, further cause the at least one processor to, when determining the target transmission device includes:
determine all wireless units transmitting the uplink signal based on the second transmission parameter, and determine one or more candidate transmission devices to which the wireless units belong;
calculate a sum of third transmission sub-parameters of all wireless units of each candidate transmission device, the third transmission sub-parameter being a sub-parameter in the second transmission parameter; and
determine one of the one or more candidate transmission devices with a smallest sum as the target transmission device.

11. The electronic device according to claim 7, wherein the one or more instructions, when executed by the at least one processor, further cause the at least one processor to, when determining the target transmission device:
determine all wireless units transmitting the uplink signal based on the second transmission parameter, and determining one or more candidate transmission devices to which the wireless units belong;
calculate a sum of third transmission sub-parameters of all wireless units of each candidate transmission device, the third transmission sub-parameter being a sub-parameter in the second transmission parameter; and
determine one of the one or more candidate transmission devices with the sum less than a threshold as the target transmission device.

12. The electronic device according to claim 7, wherein:
the target transmission device is one of at least one target transmission device; and
the one or more instructions, when executed by the at least one processor, further cause the at least one processor to:
determine all wireless units transmitting the uplink signal based on the second transmission parameter, and determine one or more candidate transmission devices to which the wireless units belong;
calculate a sum of third transmission sub-parameters of all wireless units of each candidate transmission device, the third transmission sub-parameter being a sub-parameter in the second transmission parameter; and
in response to determining that a number of candidate transmission devices having the sum less than a first threshold exceeds a second set threshold, select a set number of candidate transmission devices according to an ascending order of the sums of the candidate transmission devices as the at least one target transmission device.

13. A non-transitory computer-readable storage medium storing one or more instructions that, when executed by at least one processor, cause the at least one processor to:
obtain an uplink signal;
obtain a first transmission parameter and a second transmission parameter of the uplink signal based on the uplink signal and transmission data carried in the uplink signal, the first transmission parameter representing a demodulation attribute of the uplink signal transmission data and the second transmission parameter representing a quality attribute of the uplink signal transmission data;
determine a target transmission device based on the second transmission parameter;
select a first transmission sub-parameter associated with the target transmission device in the first transmission parameter, and select a second transmission sub-parameter associated with the target transmission device in the second transmission parameter, the first transmission sub-parameter and the second transmission sub-parameter being associated with an uplink signal of the target transmission device; and
determine a third transmission parameter of the uplink signal based on the first transmission sub-parameter and the second transmission sub-parameter.

14. The storage medium according to claim 13, wherein
the uplink signal is a first uplink signal and the transmission data is first transmission data;
the one or more instructions, when executed by the at least one processor, further cause the at least one processor to:
obtain a second uplink signal; and
parse second transmission data in the second uplink signal at least based on the third transmission parameter; and
the first uplink signal is a sub-signal in the second uplink signal, and the first transmission data is sub-data in the second transmission data.

15. The storage medium according to claim 14, wherein the one or more instructions, when executed by the at least one processor, further cause the at least one processor to, when obtaining the first transmission parameter and the second transmission parameter of the first uplink signal:
in response to attribute information of the second uplink signal, determine the first uplink signal in a timing sequence of the second uplink signal;
determine a correlation parameter between the first uplink signal and the first transmission data as the first transmission parameter;
calculate a fourth transmission parameter based on the first transmission parameter and the first uplink signal; and
calculate the second transmission parameter based on the fourth transmission parameter.

16. The storage medium according to claim 13, wherein the one or more instructions, when executed by the at least one processor, further cause the at least one processor to, when determining the target transmission device includes:
determine all wireless units transmitting the uplink signal based on the second transmission parameter, and determine one or more candidate transmission devices to which the wireless units belong;
calculate a sum of third transmission sub-parameters of all wireless units of each candidate transmission device, the third transmission sub-parameter being a sub-parameter in the second transmission parameter; and
determine one of the one or more candidate transmission devices with a smallest sum as the target transmission device.

17. The storage medium according to claim 13, wherein the one or more instructions, when executed by the at least one processor, further cause the at least one processor to, when determining the target transmission device:
determine all wireless units transmitting the uplink signal based on the second transmission parameter, and determining one or more candidate transmission devices to which the wireless units belong;
calculate a sum of third transmission sub-parameters of all wireless units of each candidate transmission device, the third transmission sub-parameter being a sub-parameter in the second transmission parameter; and
determine one of the one or more candidate transmission devices with the sum less than a threshold as the target transmission device.

18. The storage medium according to claim 13, wherein:
the target transmission device is one of at least one target transmission device; and
the one or more instructions, when executed by the at least one processor, further cause the at least one processor to:
determine all wireless units transmitting the uplink signal based on the second transmission parameter, and determine one or more candidate transmission devices to which the wireless units belong;
calculate a sum of third transmission sub-parameters of all wireless units of each candidate transmission device, the third transmission sub-parameter being a sub-parameter in the second transmission parameter; and
in response to determining that a number of candidate transmission devices having the sum less than a first threshold exceeds a second set threshold, select a set number of candidate transmission devices according to an ascending order of the sums of the candidate transmission devices as the at least one target transmission device.
